(19) United States
(12) Patent Application Publication
(10) Pub. No.: US 2009/0213223 A1
(43) Pub. Date: Aug. 27, 2009

(54) TESTING SYSTEM FOR A VIDEO CARD AND A TESTING METHOD THEREOF

(75) Inventor: XIANG-YUN KONG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/129,981

(22) Filed: May 30, 2008

(30) Foreign Application Priority Data
Feb. 21, 2008 (CN) 200810300373.5

(51) Int. Cl. H04N 17/00

(52) U.S. Cl. 348/181; 348/E17.001

(57) ABSTRACT

A testing system includes a computer (10) and a signal switching adapter (30). The computer includes a test signal generating element (19) and a microprocessor (15). The test signal generating element is capable of generating an original test signal. The microprocessor (15) is capable of communicating with the test signal generating element. A video card (11) is capable of receiving the original test signal from the microprocessor and outputting a to-be-displayed analog signal. The signal switching adapter includes an A/D converter (32). The A/D converter is capable of converting the to-be-displayed analog signal to a digital display signal. The signal switching adapter is capable of outputting the digital display signal back to the microprocessor.

### BACKGROUND

1. Technical Field

The present invention relates to a testing system for a video card and a testing method thereof, especially to a testing system for a video card with a video graphic array (VGA).

2. Description of Related Art

Video cards are important components in computers. How well things are displayed by a computer depends on the performance of the video card used. A performance test of the video card before the video card is put in use is needed.

A traditional video card testing method includes the steps of: connecting an output connector of the video card to a display and using test video to produce images in the display. Then the images are observed by an operator gauge performance of the current video card. This traditional method is labor intensive and is inefficient in mass production environments. Further the observed test video image may be affected by performance problems of the display.

What is needed, therefore, is a reliable automatic video card testing system.

### SUMMARY

A testing system includes a computer and a signal switching adapter. The computer includes a test signal generating element and a microprocessor. The test signal generating element is capable of generating an original test signal. The microprocessor is capable of communicating with the test signal generating element. A video card is capable of receiving the original test signal from the microprocessor and outputting a to-be-displayed analog signal. The signal switching adapter includes an A/D converter. The A/D converter is capable of converting the to-be-displayed analog signal to a digital display signal. The signal switching adapter is capable of outputting the digital display signal back to the microprocessor.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic diagram of a connecting relationship of a testing system for a video card in the present invention; and

FIG. 2 is a flow diagram of a testing method for a video card in the present invention.

### DETAILED DESCRIPTION OF THE EMBODIMENT

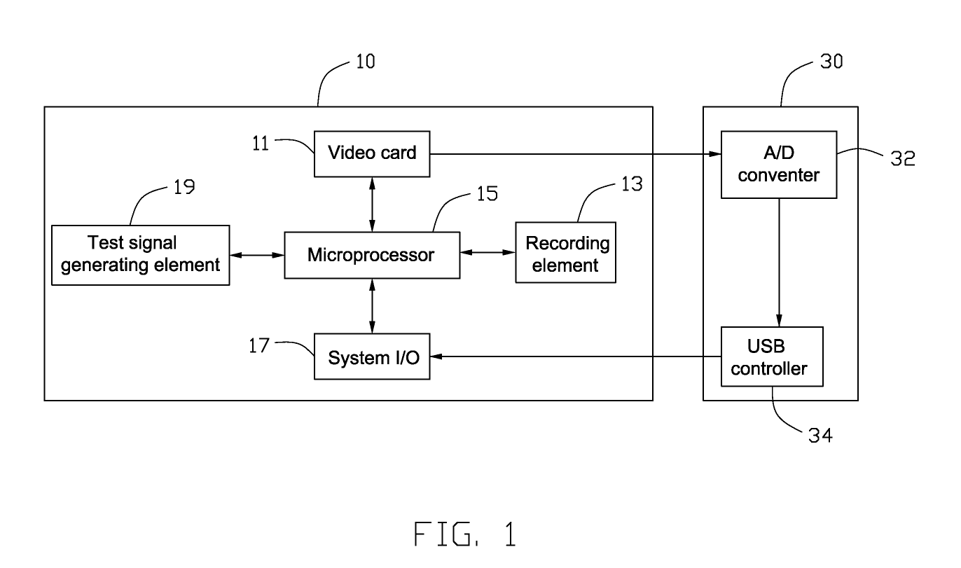

Referring to FIG. 1, a testing system for testing a video processing effect of a video card is provided. The testing system includes a computer 10 and a signal switching adapter 30. The computer 10 includes a test signal generating element 19, a system I/O (input/output) 17, a recording element 13, and a microprocessor 15 connecting to the test signal generating element 19, the system I/O 17 and the recording element 13. A to-be-tested video card 11 is integrated in the computer 10 or pluggable to the computer 10 through a peripheral component interconnect (PCI) or an accelerated graphics port (AGP) connector. The video card 11 is connected to the microprocessor 15. The video card 11 is a VGA card, which has a VGA port to output analog video signals to a display. The video card 11 has red, green and blue video outputs. The test signal generating element 19 is a storage device with test software embedded therein that can generate and output an original test signal to the video card 11 through the microprocessor 15. The recording element 13 can record a result from the microprocessor 15.

The signal switching adapter 30 includes an analog/digital (A/D) converter 32 connected to the output port of the video card 11, and a USB controller 34 connected to the system I/O 17 of the computer 10. The A/D converter 32 is used to convert an analog signal to a digital signal. The USB controller 34 controls the digital display signal from the A/D converter 32 to output through a USB port. Power for the signal switching adapter 30 can be acquired from the computer 10 through the USB controller 34.

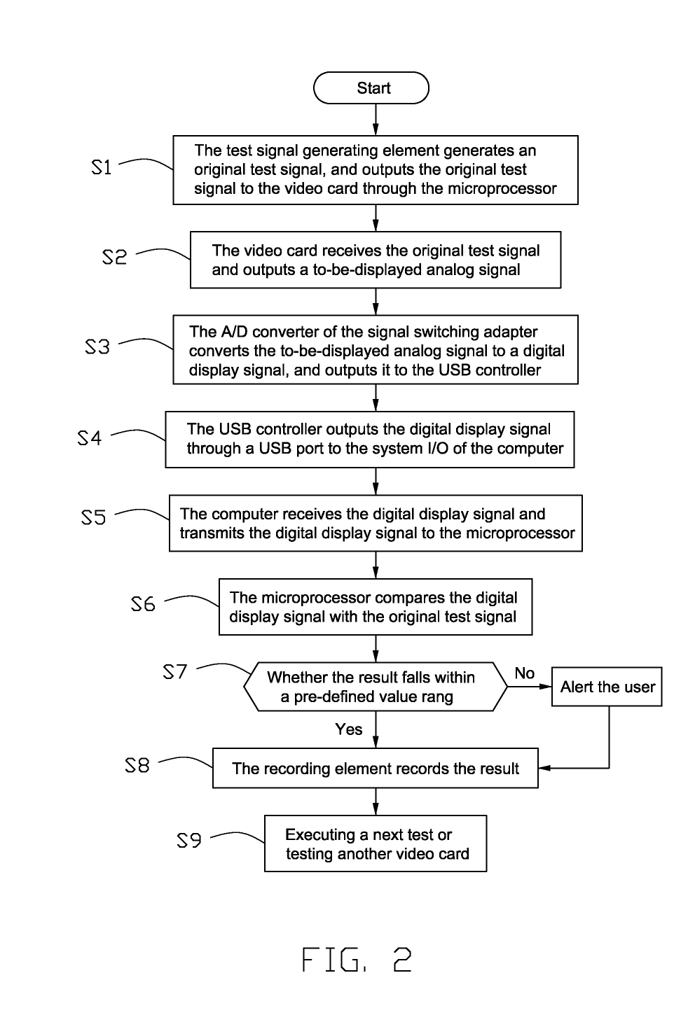

Referring to FIG. 2, a testing method includes the following steps.
Step S1: the test signal generating element 19 generates an original test signal, and outputs the original test signal to the video card 11 through the microprocessor 15;
Step S2: the video card 11 receives the original test signal and outputs a to-be-displayed analog signal through the VGA port thereof after processing the original test signal, this analog display signal can also be displayed in a monitor;
Step S3: the A/D converter 32 of the signal switching adapter converts the to-be-displayed analog signal to a digital display signal, and outputs it to the USB controller 34;
Step S4: the USB controller 34 outputs the digital display signal through a USB port to the system I/O 17 of the computer 10;
Step S5: the computer 10 receives the digital display signal and transmits the digital display signal to the microprocessor 15, thereby the testing signal is fed back to the microprocessor 15;
Step S6: the microprocessor 15 compares the digital display signal with the original test signal;
Step S7: if the result falls within a pre-defined value range, the video card is good, and step S8 is next, and if the result does not fall within the pre-defined range, the video card is bad, and the computer will alert the user before going to step S8;
Step S8: the recording element 13 records the result;
Step S9: executing a next test or testing another video card.
   In the step S2, a monitor can also be connected to the video card 11 to simultaneously display a test video for visual observation by a user.

The testing system for a video card and the testing method have the following advantages: first, the video card is tested by the computer which receives the video card; second, the signal switching adapter can be detachably applied to any computer with a VGA video card; third, the testing process is automatically realized, no human tester is needed in the test process, and the results of the testing are more reliable.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A testing system comprising:
a computer comprising:
a test signal generating element being capable of generating an original test signal;
a microprocessor being capable of communicating with the test signal generating element; and
a video card being capable of receiving the original test signal from the microprocessor and outputting a to-be-displayed analog signal;
a signal switching adapter comprising an A/D converter being capable of converting the to-be-displayed analog signal to a digital display signal, the signal switching adapter being capable of outputting the digital display signal back to the microprocessor, wherein the microprocessor is capable of comparing the digital display signal with the original test signal to test an effect of the video card.

2. The testing system as claimed in claim 1, wherein the computer further comprises a system I/O, and the system I/O is capable of receiving the digital display signal and outputting the digital signal to the microprocessor.

3. The testing system as claimed in claim 1, wherein the signal switching adapter further comprises a USB controller, and the USB controller is capable of outputting the digital display signal from the A/D converter through a USB output port.

4. The testing system as claimed in claim 1, wherein the computer further comprises a recording element, and the recording element is capable of communicating with the microprocessor and recording a result therefrom.

5. The testing system as claimed in claim 1, wherein the teat signal generating element is a storage device with test software embedded therein.

6. The testing system as claimed in claim 1, wherein the video card is a VGA card with a VGA output port.

7. A testing method comprising:
connecting a video card to a computer;
a test signal generating element of the computer generating an original test signal and outputting the original test signal to the video card through a microprocessor of the computer;
the video card receiving the original test signal and outputting a to-be-displayed analog signal;
a signal switching adapter receiving the to-be-displayed analog signal and converting the to-be-displayed analog signal into a digital display signal;
the signal switching adapter outputting the digital display signal back to the microprocessor of the computer; and
the microprocessor comparing the digital display signal with the original test signal.

8. The method as claimed in claim 7, wherein the steps further comprises the computer receiving the digital display signal by a system I/O.

9. The method as claimed in claim 7, wherein the steps further comprises outputting the digital display signal through a USB output port of a USB controller.

10. The method as claimed in claim 7, wherein the steps further comprises recording a result of the microprocessor by a recording element.

11. The method as claimed in claim 7, wherein the test signal generating element is a storage device with test software embedded therein.

12. The method as claimed in claim 7, wherein the video card is a VGA card with a VGA output port.

13. The method as claimed in claim 7, wherein the steps further comprises judging if a result falls within a pre-defined value range to acquire a result of the video card.
